(19) United States
(12) Patent Application Publication
(10) Pub. No.: US 2014/0040789 A1
(43) Pub. Date: Feb. 6, 2014

(54) TOOL CONFIGURATION HISTORY IN A USER INTERFACE

(71) Applicants: Aaron D. Munter, San Francisco, CA (US); Remon Tijssen, Mill Valley, CA (US)

(72) Inventors: Aaron D. Munter, San Francisco, CA (US); Remon Tijssen, Mill Valley, CA (US)

(73) Assignee: Adobe Systems Incorporated, San Jose, CA (US)

(21) Appl. No.: 13/466,889

(22) Filed: May 8, 2012

(51) Int. Cl. G06F 3/048

(52) U.S. Cl. 715/762

(57) ABSTRACT

An example device may present content within a user interface on a display screen. The user interface may support a tool that is controllable by a user to modify the content. Such a tool may be configurable to have various effects on the content. The tool may have a current configuration that specifies a current effect of the tool on the content presented in the user interface, and the current configuration may be distinct from a previous configuration that specifies a previous effect of the tool on the content. The device presents a first icon that indicates the current configuration of a tool and may present a second icon that indicates a previous configuration of the tool. The device may detect user input that indicates a request that the current configuration be replaced with the previous configuration. The device may configure the tool according to the previous configuration.

### TECHNICAL FIELD

The subject matter disclosed herein generally relates to the processing of data. Specifically, the present disclosure addresses systems and methods that involve presentation of tool configuration history in a user interface.

### BACKGROUND

A machine (e.g., a device such as a tablet, a smartphone, or a computer) may execute an application with which a user may interact via a user interface. For example, a computer may execute an image processing application that configures the computer to display and edit an image, and the image processing application may configure the computer to present a user interface on a display of the computer. As another example, a tablet may execute a video editing application that configures the tablet to display and modify a video (e.g., a movie) within a user interface presented on a display that is integrated into the tablet. As a further example, a smart phone may execute a word processor application that configures the smart phone to generate (e.g., author) or edit a document, or the word processor application causes the smart phone to display the user interface for generating or editing the document.

A user interface may include one or more tools with which a user may interactively work with (e.g., generate or edit) the contents of the user interface or some portion thereof. For example, a user interface for editing a video may include a text overlay tool that is operable by a user to add text to a frame of video. As another example, a user interface for editing an image may include a pencil tool that is operable by a user to draw lines or marks on an image. As a further example, a user interface for editing a document may include a highlighter tool operable by a user to change the color of the document (e.g., near text within the document).

### BRIEF DESCRIPTION OF THE DRAWINGS

Some embodiments are illustrated by way of example and not limitation in the figures of the accompanying drawings.

FIG. 1 is a block diagram illustrating components of a device configurable to support tool configuration history in a user interface, according to some example embodiments.

FIG. 2-9 are user interface diagrams illustrating content being displayed on a display screen of a device, along with icons for configuring a tool with which a user may interactively work with the content displayed, according to some example embodiments.

FIG. 10-12 are flowcharts illustrating operations of the device in performing a method that involves presentation of tool configuration history in a user interface, according to some example embodiments.

FIG. 13 is a block diagram illustrating components of a machine, according to some example embodiments, able to read instructions from a machine-readable medium and perform any one or more of the methodologies discussed herein.

### DETAILED DESCRIPTION

Example methods and systems are directed to tool configuration history in a user interface. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

A device may be configured to present content within a user interface, and the user interface may be presented on a display screen of the device. The user interface may include, provide, or support a tool that is controllable by a user to modify the content (e.g., modify an attribute of the content). Such a tool may be configurable (e.g., by the user via the user interface) to have various effects on the content (e.g., modify an attribute of the content in various ways). The configuration of the tool may therefore vary over time. For example, the tool may have a current configuration that specifies a current effect of the tool on an attribute of the content presented in the user interface, and the current configuration may be distinct from a previous configuration that specifies the previous effect of the tool on the same attribute of the content. As used herein, a “configuration” of a tool refers to information (e.g., data) that defines, specifies, or identifies a configurable aspect of the tool. Such information may specify one or more parameters or values of the configurable aspect of the tool (e.g., a single value for a size of the brush tool, or three color component values for a color of a brush tool). Where a tool has multiple configurable aspects (e.g., size and color of a brush tool), a configuration of the tool may configure a single aspect of the tool (e.g., size only, or color only). Accordingly, a configuration of the tool may be a full configuration or a partial configuration.

In accordance with various example embodiments discussed herein, the device may present (e.g., on its display screen) a first icon that indicates the current configuration of a tool. The device may further present a second icon that indicates a previous configuration of the tool. The user may provide input that indicates a request that the current configuration be replaced with the previous configuration. The device may detect (e.g., receive or access) this request, and in response to this request, the device may configure the tool according to the previous configuration.

Furthermore, the user input detected may be a cursor movement (e.g., on the display screen), a gesture (e.g., performed on a touch-sensitive display screen or performed within range of a motion detector), or any suitable combination thereof. According to various example embodiments, such a cursor movement or gesture may be of any length or duration. For example, some or all of the cursor movement or gesture may occur within an area of the first icon (e.g., that indicates the current configuration of the tool), within an area of the second icon (e.g., that indicates the previous configuration of the tool), or both.

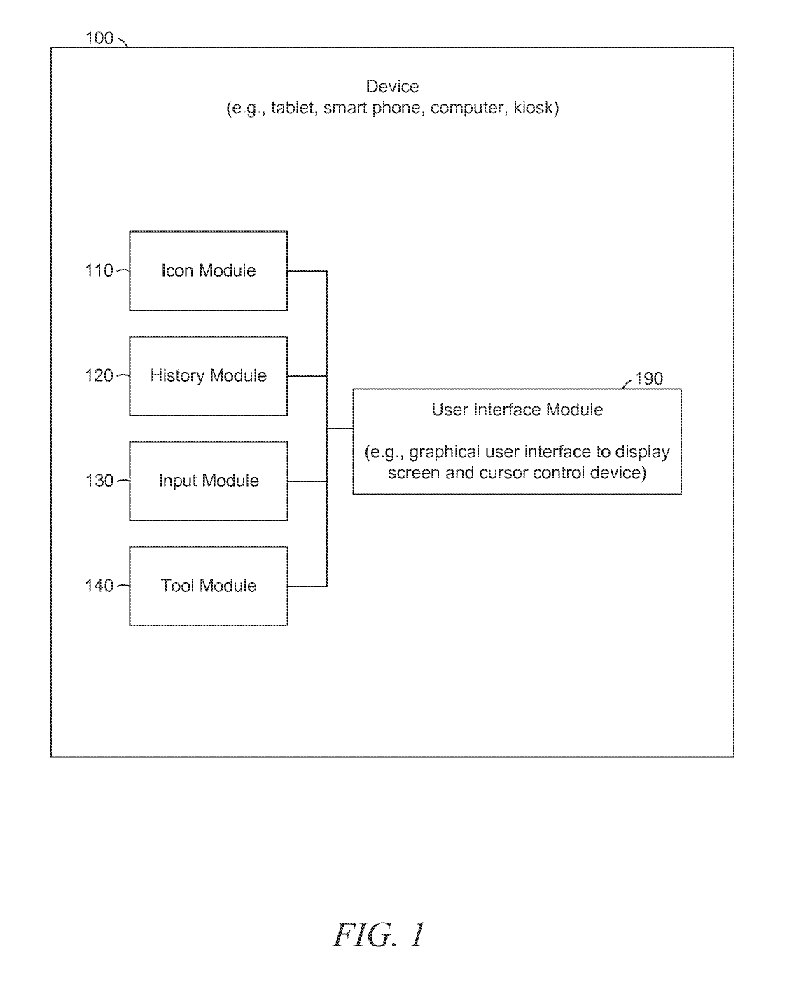

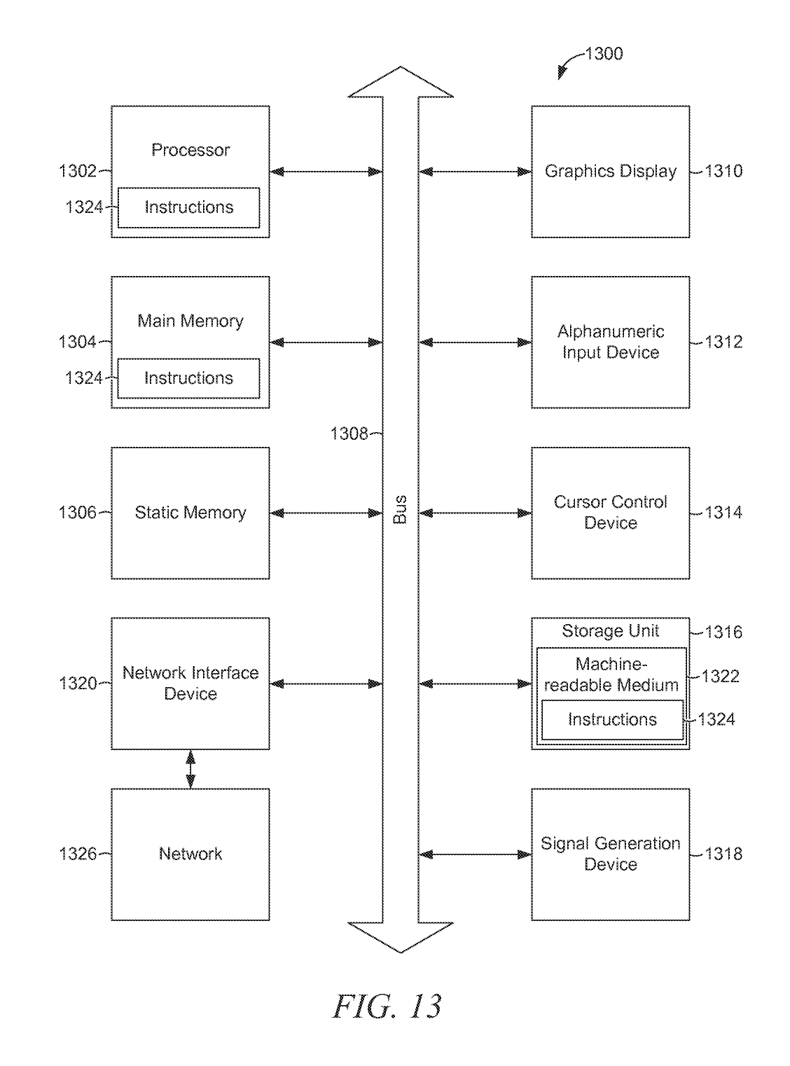

FIG. 1 is a block diagram illustrating components of a device 100 configurable to support tool configuration history in a user interface, according to some example embodiments. The device 100 may be implemented in a computer system, in whole or in part, as described below with respect to FIG. 13. For example, the device 100 may be a desktop computer, a vehicle computer, a tablet computer, a navigational device, a portable media device, or a smart phone (e.g., belonging to a user). Moreover, the device 100 may be communicatively coupled (e.g., connected) to one or more networks. For example, the device 100 may be connected to a network that enables communication between machines (e.g., the device 100 and a server machine, such as a web server or application server). Accordingly, such a network may be a wired network, a wireless network (e.g., a mobile or cellular network), or any suitable combination thereof. Furthermore, such a network may include one or more portions that constitute a private network, a public network (e.g., the Internet), or any suitable combination thereof.

According to various example embodiments, the device 100 may be implemented in a general-purpose computer modified (e.g., configured or programmed) by software to be a special-purpose computer to perform the functions described herein for that machine. For example, a computer system able to implement any one or more of the methodologies described herein is discussed below with respect to FIG. 13. Furthermore, the device 100 may be implemented as a single machine, or the functions described herein for the device 100 may be subdivided among multiple machines.

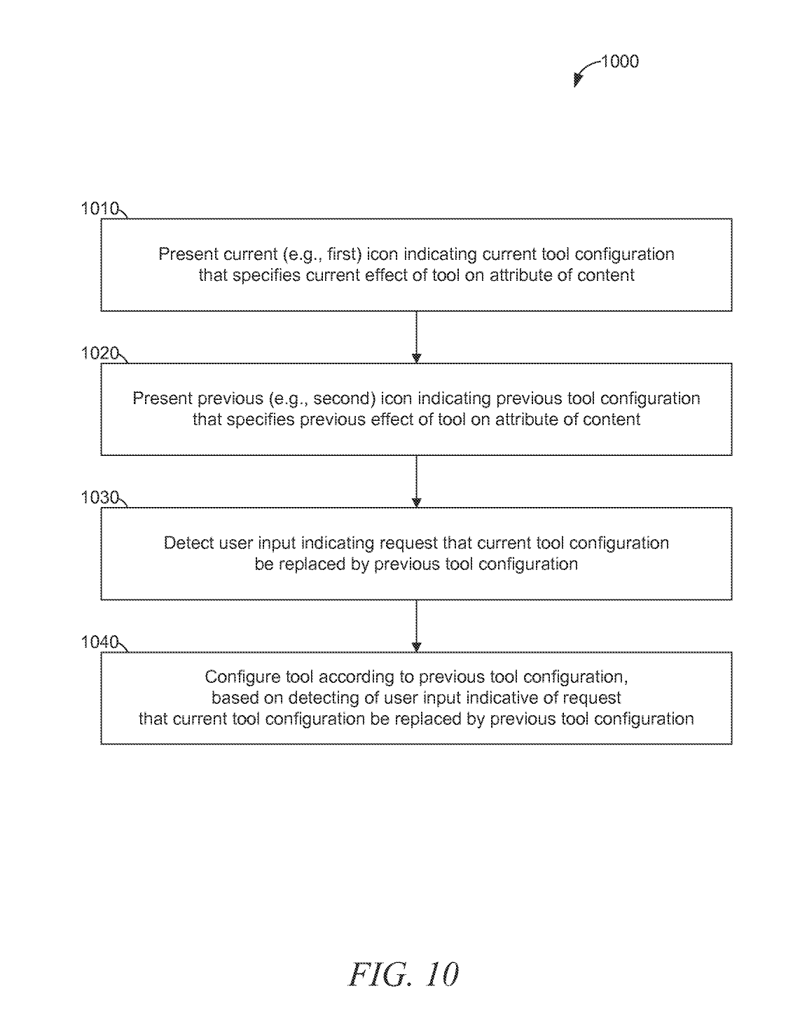

As shown in FIG. 1, the device 100 may include an icon module 110, a history module 120, an input module 130, a tool module 140, and a user interface module 190, all configured to communicate with each other (e.g., via a bus, shared memory, or a switch). Any one or more of the modules described herein may be implemented using hardware (e.g., a processor of a machine) or a combination of hardware and software. For example, any module described herein may configure a processor to perform the operations described herein for that module. Moreover, any two or more of these modules may be combined into a single module, and the functions described herein for a single module may be subdivided among multiple modules. Functions of the icon module 110, the history module 120, the input module 130, and a tool module 140 are described below with respect to FIG. 10-12. The user interface module 190 is configured to facilitate communication among the various modules shown in FIG. 1, a display screen of the device 100, a cursor control device or component of the device 100, or any suitable combination thereof.

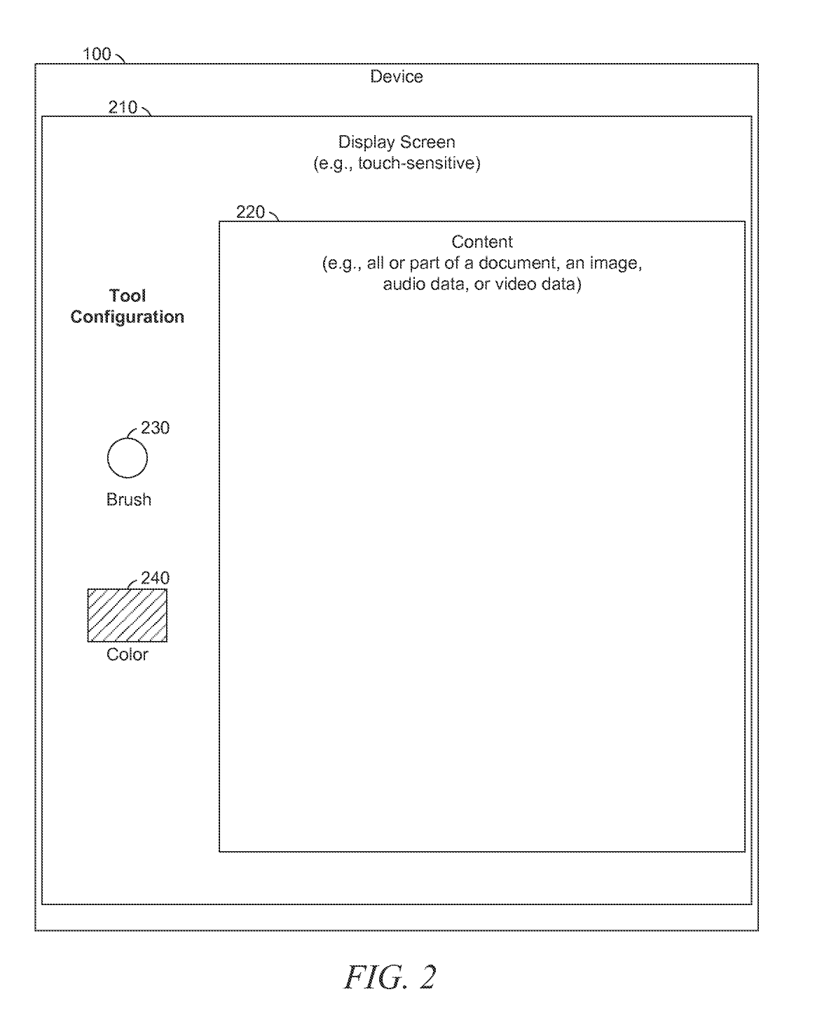

FIG. 2-9 are user interface diagrams illustrating content 220 being displayed on a display screen 210 of the device 100, along with icons 230 and 240 for configuring a tool (e.g., a paintbrush tool for editing an image) with which a user may interactively work with the content 220, according to some example embodiments. As shown in FIG. 2, the device 100 may include the display screen 210, which may be communicatively coupled to the user interface module 190 of the device 100. For example, the device 100 may be a tablet or a smart phone, and the display screen 210 may be an electronic display screen (e.g., touch-sensitive) built into the tablet or the smartphone. As another example, the device 100 may be a computer (e.g., a notebook computer), and the display screen 210 may be an electronic display screen (e.g., touch-sensitive or non-touch-sensitive) built into the computer. In some example embodiments, the display screen 210 is external to the device 100 and connected thereto (e.g., by a wired or wireless interface).

The display screen 210 presents (e.g., displays) the content 220, which may be any aggregate of information displayable by the display screen 210. For example, the content 220 may include all or part of a document, all or part of an image, audio data, video data, or any suitable combination thereof. According to various example embodiments, the device 100 may execute one or more applications to present (e.g., display, play, or view) the content 220, edit (e.g., modify, alter, or revise) the content 220, or both. Examples of such an application include a word processing application, a graphical illustration application, an image editing application, a presentation editor (e.g., a slideshow authoring application), an audio editing application (e.g., a non-linear editor for audio data), a video editing application (e.g., a non-linear editor for video data or movie data), a multi-track media editing application (e.g., a non-linear editor for multiple streams of audio data and video data), and any suitable combination thereof. Such an application may provide a tool with which a user may interactively modify the content 220.

In particular, the content 220 may have an attribute (e.g., among multiple attributes) that is modifiable to modify the content 220. Examples of modifiable attributes of a document include the text of the document, text color, typeface (e.g., font), and text size. Examples of modifiable attributes of an image include the pixels of the image, pixel color, and pixel transparency. Examples of modifiable attributes of audio data include the audio samples of an audio file, loudness, and dynamic range. Examples of modifiable attributes of video data include the frames of a video file, pixels within a video frame, brightness, and contrast. Such an attribute of the content 220 may be modifiable through the use of one or more tools provided by an application executing on the device 100. For example, a tool may enable a user of the device 100 to indicate (e.g., specify or designate) a portion of the content 220 to be affected (e.g., modified) by the tool.

Moreover, the tool may be configurable to affect some or all of the content 220 in various ways. That is, the application may support multiple configurations of the tool, and the multiple configurations may be selectable by the user, thus allowing the user to specify an effect of the tool upon the attribute of the content 220, when the tool is applied to some or all of the content 220. Furthermore, the tool may be configurable in multiple ways.

In the example embodiments illustrated in FIG. 2-9, the tool may be a paintbrush tool (e.g., for editing an image), and this paintbrush tool may be configurable with respect to size and color (e.g., independently). As shown in FIG. 2, the icon 230 indicates a current configuration of the tool (e.g., a particular brush size). This current configuration may specify a current effect of the tool (e.g., painting a medium-sized circular area of pixels) on an attribute (e.g., pixels) of the content 220 (e.g., an image). As another example, the icon 240 indicates a current configuration of the tool (e.g., a particular color of the brush). This current configuration may similarly specify a current effect of the tool (e.g., painting with the particular color) on an attribute (e.g., pixels) of the content 220 (e.g., the image). Accordingly, one or both of the icons 230 and 240 may indicate to a user how a portion of the content 220 will be modified when the tool is applied to that portion of the content 220.

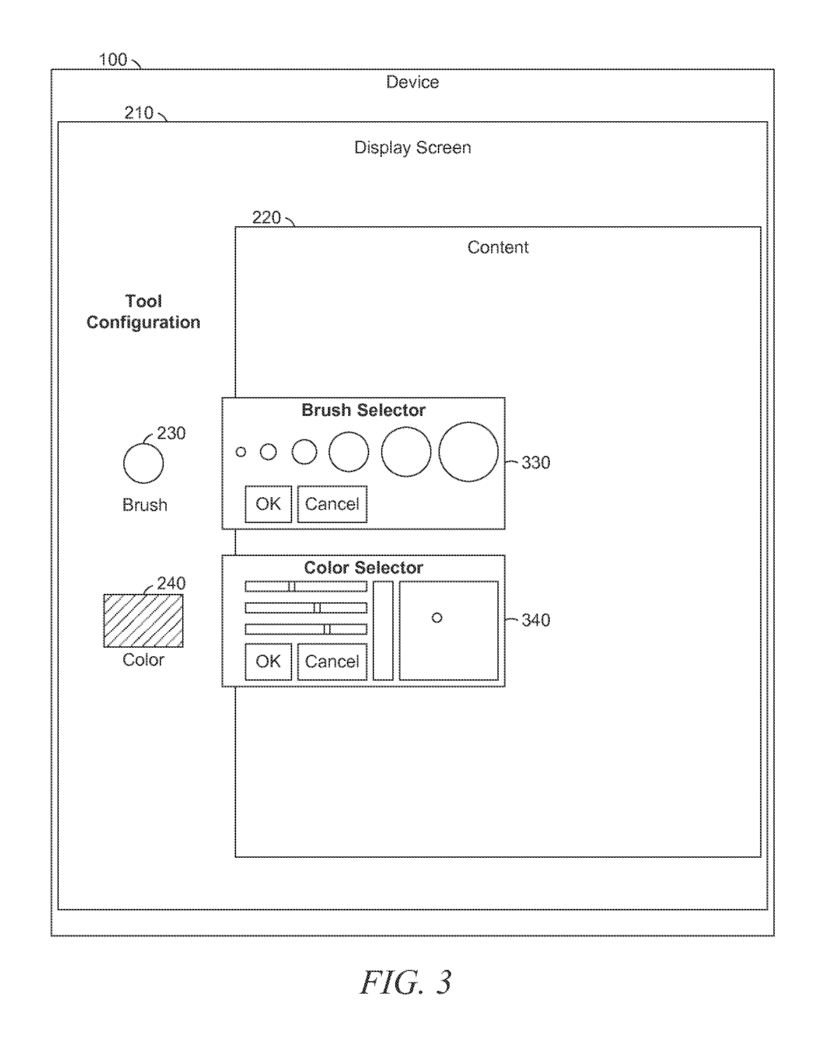

As shown in FIG. 3, the tool may be configurable in multiple ways. A configuration interface 330 may appear near or adjacent to the icon 230 (e.g., obscuring a portion of the content 220), and the configuration interface 330 may be operable to request a change in the configuration of the tool (e.g., the paintbrush tool). That is, the configuration interface 330 may be operable by a user to submit user input indicating a request that the current configuration of the tool (e.g., the current brush size) be replaced with a new configuration of the tool (e.g., a different brush size). For example, the configuration interface 330 may include a selection of brush sizes from which the user may choose a new brush size for the tool (e.g., a differently sized circular area of pixels). In response to operation of the configuration interface 330, the device 100 may reconfigure the tool according to the new configuration selected by the user (e.g., configure the tool to begin using the new brush size).

As another example, a configuration interface 340 may appear near or adjacent to the icon 240 (e.g., obscuring a portion of the content 220), and the configuration interface 340 may be operable to request a change in the configuration of the tool. The configuration interface 340 may be operable by the user to submit user input indicating a request that the current configuration of the tool (e.g., the current color of the brush) be replaced with a different configuration of the tool (e.g., a different color of the brush). As shown, the configuration interface 340 may include a color map, a set of slider bars, or any suitable combination thereof, that individually or collectively allow a user to choose a new color for the tool (e.g., a different color to be painted by the brush). In response to operation of the configuration interface 340, the device 100 may reconfigure the tool according to the new configuration selected by the user (e.g., configure the tool to begin using the new color of the brush).

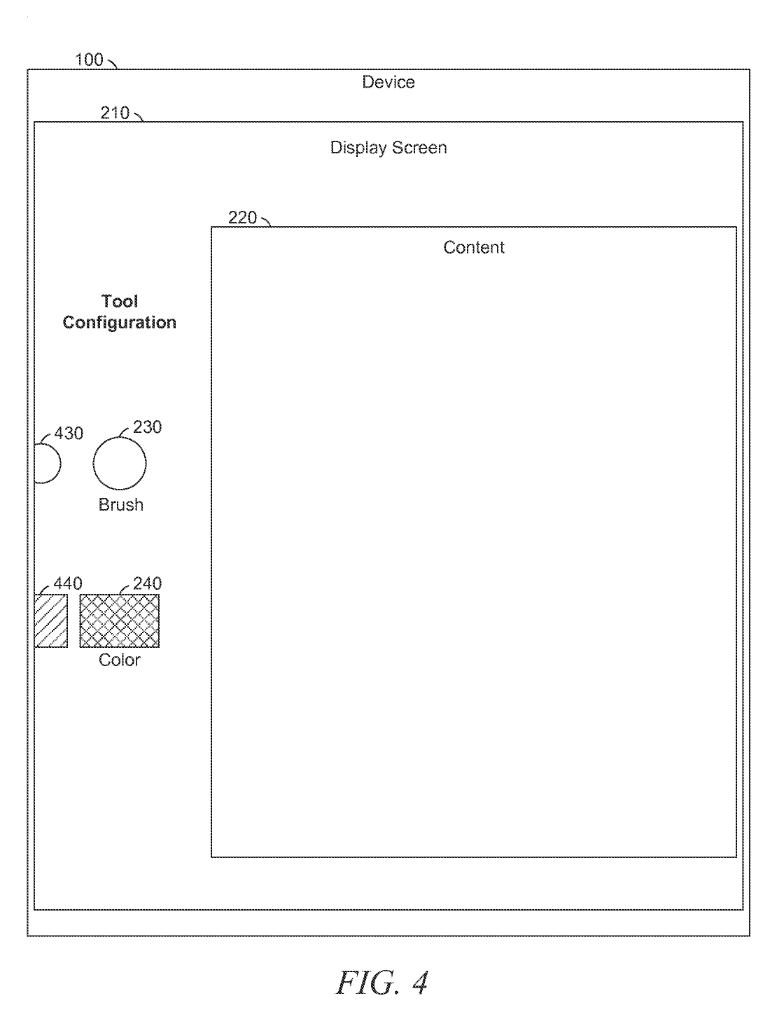

As shown in FIG. 4, the icon 230 is altered (e.g., by the device 100) to indicate the new configuration of the tool (e.g., the new brush size) requested by the user via the configuration interface 330. Similarly, the icon 240 is altered to indicate the new configuration of the tool (e.g., the new color of the brush) requested by the user via the configuration interface 340. In other words, the current configuration of the tool is indicated in FIG. 4 by the icons 230 and 240.

In addition, the display screen 210 may present (e.g., display) icons 430 and 440 to indicate the previous configuration of the tool (e.g., the tool configuration previously described as the “current condition” above with respect to FIG. 1). The icon 430 may appear to the left of the icon 230, which may signify that the icon 430 indicates a previous configuration of the tool (e.g., a previous brush size). Similarly, the icon 440 may appear to the left of the icon 240, which may signify that the icon 440 indicates a previous configuration of the tool (e.g., a previous color of the brush). This may have the effect of allowing the user to easily compare a current configuration of the tool with a previous configuration of the tool. For example, the icon 230 may indicate that the current brush size is a large circular area, while the icon 430 may indicate that the previous brush size is (e.g., was) a medium circular area. As another example, the icon 240 may indicate that the current color of the brush is dark blue, while the icon 440 may indicate that the previous color of the brush is (e.g., was) medium red.

In some example embodiments, the position of the icon 430 to the left of the icon 230 signifies that the previous configuration of the tool (e.g., the previous brush size) was defined after the current configuration of the tool was defined (e.g., the current brush size). Similarly, the position of the icon 440 to the left of the icon 240 may signify that the previous configuration (e.g., the previous color) was defined after the current configuration (e.g., the current color). Accordingly, the icons 230, 240, 430, 440 may visually represent multiple timelines or histories of tool configurations, specifically, one timeline or history for brush size configurations and another timeline or history for brush color configurations.

The icon 430 may be represented as a cropped or truncated version of the icon 230 when the icon 230 indicated the previous configuration of the tool (e.g., the previous brush size). Likewise, the icon 440 may be represented as a cropped or truncated version of the icon 240 when the icon 240 indicated the previous configuration of the tool (e.g., the previous color of the brush).

According to various example embodiments, the device 100 (e.g., via the display screen 210) may detect user input that indicates a request that the current configuration of the tool be replaced by a previous configuration of the tool. With reference to FIG. 4, a request that the current brush size (e.g., indicated by the icon 230) be replaced by the previous brush size (e.g., indicated by the icon 430) may be detected from user input that indicates one or both of the icons 230 and 240. Such a user input may take the form of a gesture (e.g., a flick or swipe of a fingertip or a stylus on a touch-sensitive display screen, or a mouse cursor movement or drag on the display screen 210), a click (e.g., a mouse-click), a voice command, or any suitable combination thereof. Regarding gestures, a gesture may be of any length or complexity. For example, the user input may include a gesture across some or all of the icon 230 (e.g., a left-to-right movement), across some or all of the icon 430 (e.g., a left-to-right movement), or both. As another example, the user input may include a gesture across some (e.g., part) or all of the icon 240, across some or all of the icon 440, or both.

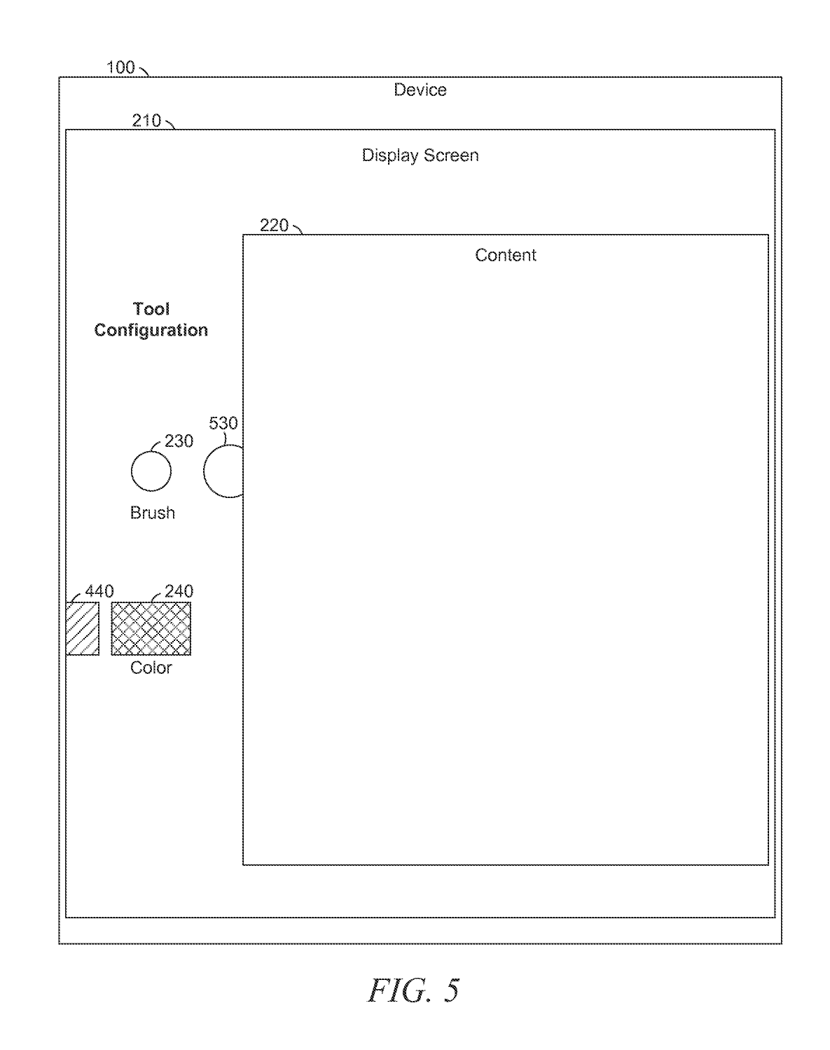

As shown in FIG. 5, the device 100 may have detected a user input across some or all of the icons 230 and 430, where the user input indicates a request that the current configuration of the tool (e.g., a large circular brush size) be replaced with the previous configuration of the tool (e.g., a medium circular brush size). In response to this user input, the device 100 may reconfigure the tool according to the previous configuration (e.g., configure the tool to begin using the medium circular brush size). As shown in FIG. 5, the icon 230 may be altered by the device 100 to indicate that the previous configuration of the tool (e.g., the medium circular brush size) is now the current configuration of the tool.

In addition, the display screen 210 may present an icon 530 to indicate that a previously used configuration of the tool (e.g., the large circular brush size) is available for selection by a user. The icon 530 may appear to the right of the icon 230, which may signify that the icon 530 indicates a previous configuration of the tool (e.g., the large circular brush size) that was defined after the current configuration of the tool (e.g., a medium circular brush size), as indicated by the icon 230. Accordingly, the icons 230 and 530 may visually represent a timeline or history of tool configurations (e.g., brush sizes).

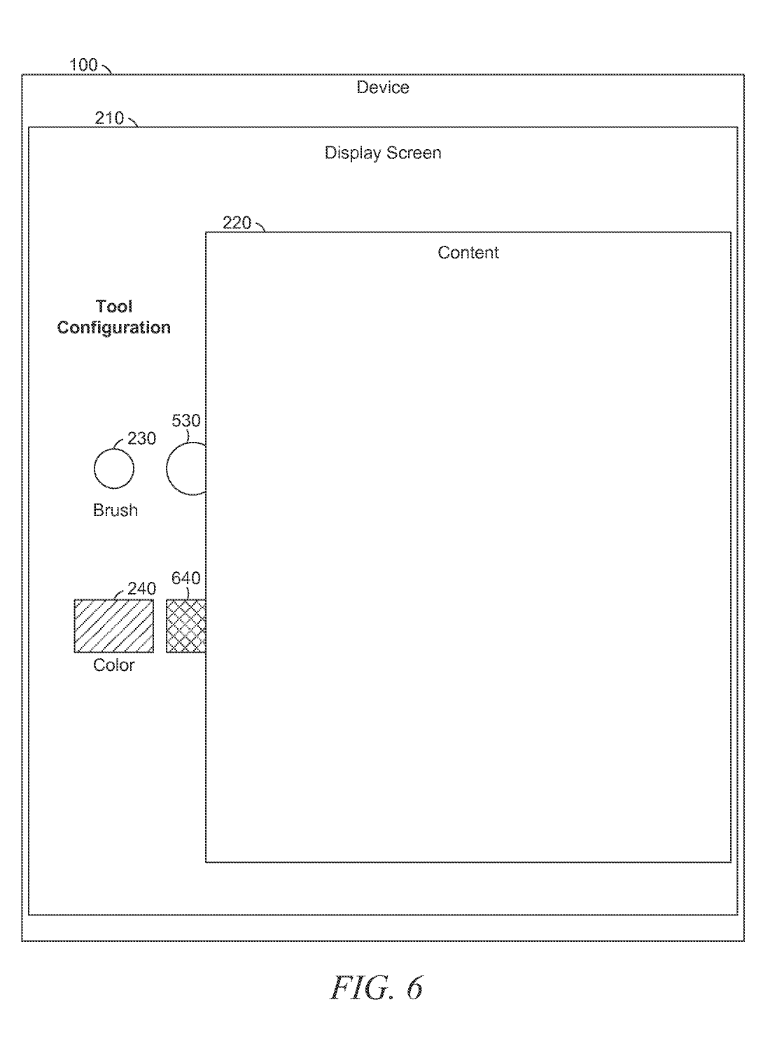

As shown in FIG. 6, the device 100 may have detected a user input across some or all of the icons 240 and 440, where the user input indicates a request that the current configuration of the tool (e.g., a dark blue color) be replaced with the previous configuration of the tool (e.g., a medium red color). In response to this user input, the device 100 may reconfigure the tool according to the previous configuration (e.g., configure the tool to begin using the medium red color). As shown in FIG. 6, the icon 240 may be altered by the device 100 to indicate that the previous configuration of the tool (e.g., the medium red color) is now the current configuration of the tool.

In addition, the display screen 210 may present an icon 640 to indicate that a previously used configuration of the tool (e.g., the dark blue color) is available for selection by the user. The icon 640 may appear to the right of the icon 240, which may signify that the icon 640 indicates a previous configuration (e.g., the dark blue color) that was defined after the current configuration of the tool (e.g., the medium red color), as indicated by the icon 240. Accordingly, the icons 240 and 640 may collectively represent a timeline or history of tool configurations (e.g., brush colors).

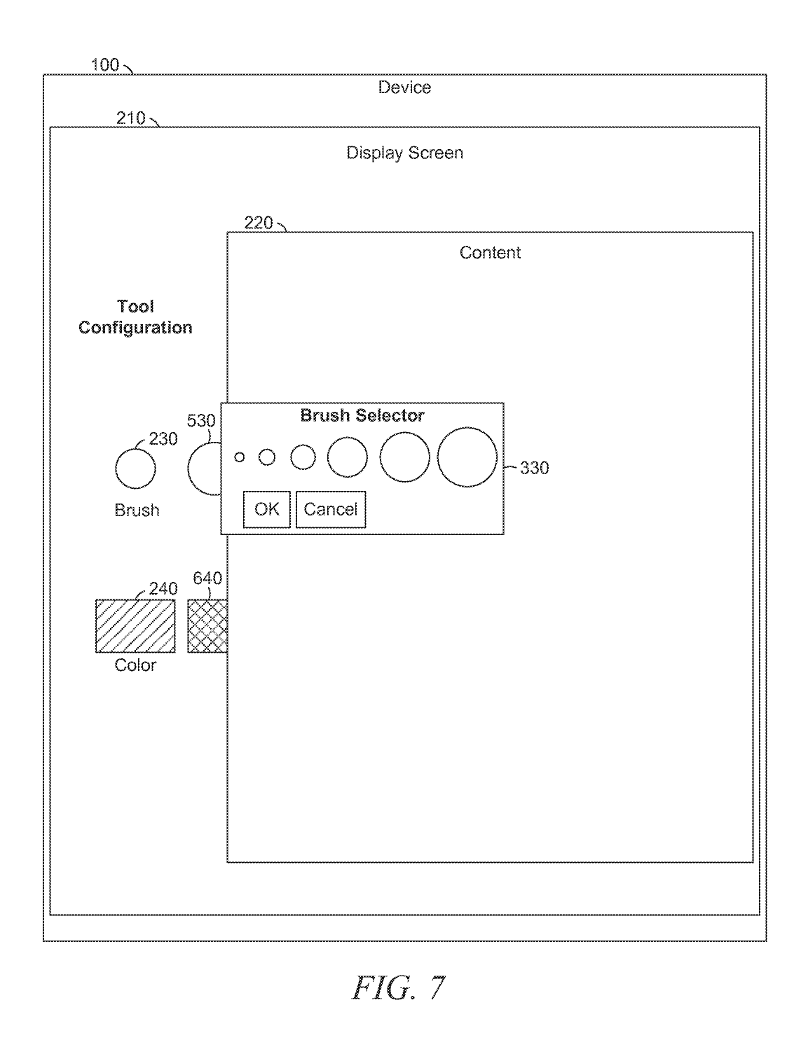

According to certain example embodiments depicted in FIG. 7-9, a configuration of a tool may be inserted into the midst of an existing timeline or history of tool configurations (e.g., inserted nondestructively, without deleting or overwriting other icons or configurations in the timeline or history). As shown in FIG. 7, the display screen 210 may present the icons 230, 240, 530, and 640, as discussed above with respect to FIG. 6. In addition, FIG. 7 shows the configuration interface 330 appearing near or adjacent to the icon 230 (e.g., partially obscuring the icon 530 and partially obscuring the content 220). As noted above, the configuration interface 330 may be operable to submit user input that indicates a request that the current configuration of the tool, as indicated by the icon 230 (e.g., a medium circular brush size), be replaced by a new configuration of the tool, as selected by the configuration interface 330 (e.g., a small circular brush size). In response to operation of the configuration interface 330, the device 100 may configure the tool according to the new configuration (e.g., configure the tool to begin using the small circular brush size).

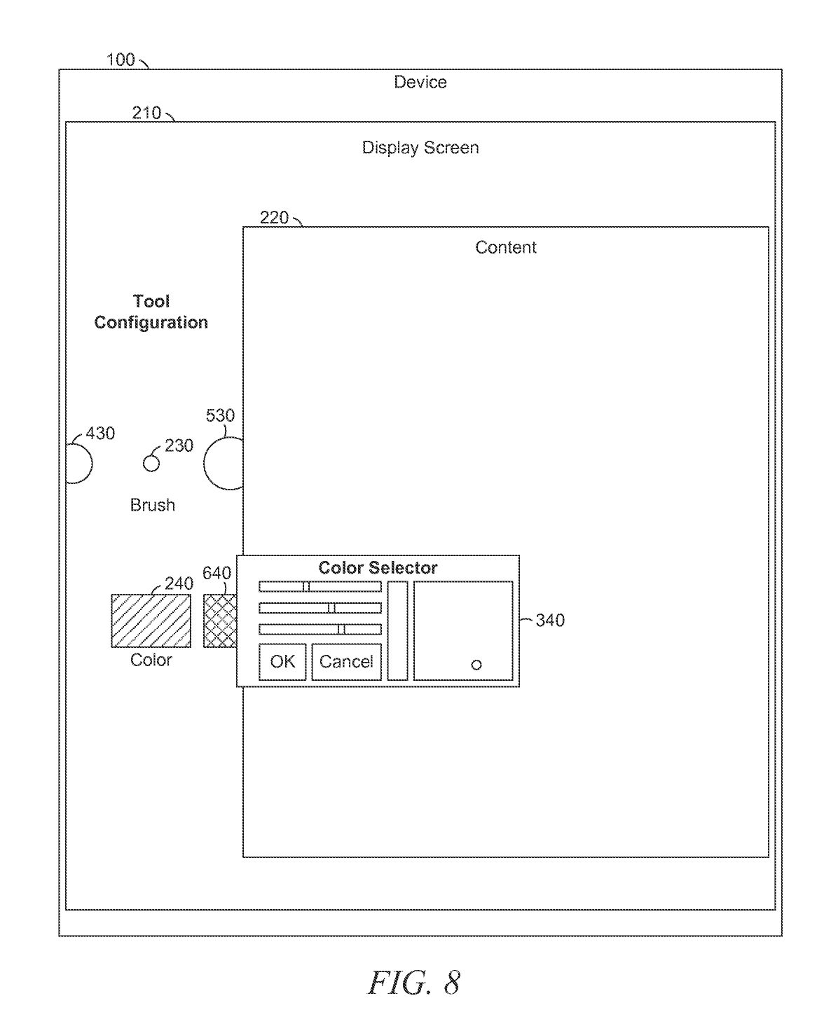

As shown in FIG. 8, the icon 230 is altered by the device 100 to indicate the new configuration (e.g., the small circular brush size) requested by the user via the configuration interface 330. In addition, the display screen 210 may present the icons 430 and 530 to respectively indicate previous configurations of the tool (e.g., the medium circular brush size and the large circular brush size). As noted above, the position of the icon 430 to left of the icon 230 may signify that the icon 430 indicates a previous configuration (e.g., the medium circular brush size) that was defined prior to the current configuration (e.g., the small circular brush size). In some example embodiments, the position of the icon 530 to the right of the icon 430 may signify that the icon 530 indicates a previous configuration the large circular brush size) that was defined after the configuration represented by the icon 430 (e.g., the medium circular brush size). Hence, the icon 230 may be visually representative of a current configuration (e.g., the small circular brush size) that was inserted into a timeline or history of tool configurations (e.g., brush sizes).

FIG. 8 also shows the configuration interface 340 appearing near or adjacent to the icon 240 (e.g., partially obscuring the icon 640 and partially obscuring the content 220). As noted above, the configuration interface 340 may be operable to submit user input that indicates a request that the current configuration of the tool, as indicated by the icon 240 (e.g., a medium red color), be replaced by a new configuration of the tool, as selected by the configuration interface 340 (e.g., a light gray color). In response to operation of the configuration interface 340, the device 100 may configure the tool according to the new configuration (e.g., configure the tool to begin using the light gray color).

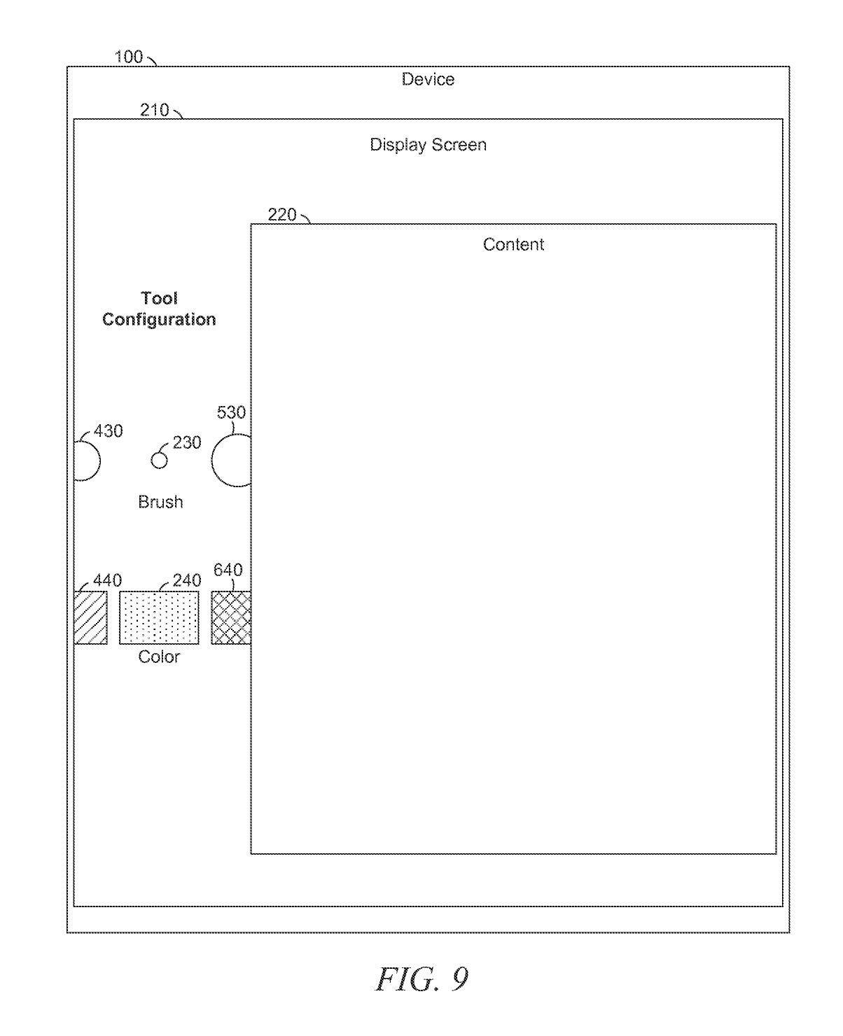

As shown in FIG. 9, the icon 240 is altered by the device 100 to indicate the new configuration (e.g., a light gray color) requested by the user via the configuration interface 340. In addition, the display screen 210 may present the icons 440 and 640 to respectively indicate previous configurations of the tool (e.g., the medium red color and the dark blue color). As noted above, the position of the icon 440 to the left of the icon 240 may signify that the icon 440 indicates a previous configuration (e.g., the medium red color) that was defined prior to the current configuration (e.g., the light gray color). In certain example embodiments, the position of the icon 640 to the right of the icon 440 may signify that the icon 640 indicates a previous configuration (e.g., the dark blue color) that was defined after the configuration represented by the icon 440 (e.g., the medium red color). Hence, the icon 240 may be visually representative of a current configuration (e.g., the light gray color) that was inserted into a timeline or history of tool configurations (e.g., brush colors).

FIG. 10-12 are flowcharts illustrating operations of the device 100 in performing a method 1000 that involves presentation of tool configuration history on the display screen 210, according to some example embodiments. Operations in the method 1000 may be performed by the device 100, using modules described above with respect to FIG. 1. As shown in FIG. 10, the method 1000 includes operations 1010, 1020, 1030, and 1040.

In operation 1010, the icon module 110 presents a first icon (e.g., icon 230) that indicates a current configuration of a tool (e.g., a paintbrush tool) within a user interface (e.g., display screen 210) in which the content 220 (e.g., an image) is presented. As noted above, the current configuration may specify a current effect (e.g., paint with a large circular brush size) of the tool on (e.g., applicable to) an attribute (e.g., color) of the content 220 presented in the user interface. In some example embodiments, the first icon (e.g., icon 230) indicates the current effect of the tool on the attribute (e.g., paint with the large circular brush size). For example, the first icon may have the appearance of the icon 230 as depicted in FIG. 2.

For example, the current configuration may specify the current effect on the attribute as a current color that is applicable to at least some of the content 220 presented in the user interface. As another example, the current configuration may specify the current effect on the attribute as a current brush (e.g., brush size or brush shape) that is operable to color at least some of the content 220 presented in the user interface.

In operation 1020, the history module 120 presents a second icon (e.g., icon 430) that indicates a previous configuration of the tool within the user interface in which the content 220 is presented. As noted above, the previous configuration may specify a previous effect (e.g., paint with a medium circular brush size) of the same tool on (e.g., applicable to) the same attribute (e.g., color) of the content 220 presented in the user interface. In some example embodiments, the second icon (e.g., icon 430) indicates the previous effect of the tool on the attribute (e.g., paint with the medium circular brush size). For example, the second icon may have the appearance of the icon 430 as depicted in FIG. 4.

For example, the previous configuration may specify the previous effect on the attribute as a previous color applicable to at least some of the contents 220 presented in the user interface. As another example, the previous configuration may specify the previous effect on the attribute as a previous brush (e.g., brush size or brush shape) operable to color at least some of the content 220 presented in the user interface.

In operation 1030, the input module 130 detects a user input indicative of a request that the current configuration of the tool be replaced with the previous configuration of the tool within the user interface. As noted above, the user input may be or include a gesture of any length (e.g., a flick of a fingertip or a stylus on a touch-sensitive display screen across the icon 230, the icon 430, or both).

In operation 1040, the tool module 140 configures the tool according to the previous configuration that may specify the previous effect of the tool on the attribute of the content 220 presented in the user interface. The configuring of the tool may be performed based on the detecting of the user input in operation 1030, where the user input indicates the request that the current configuration be replaced with the previous configuration.

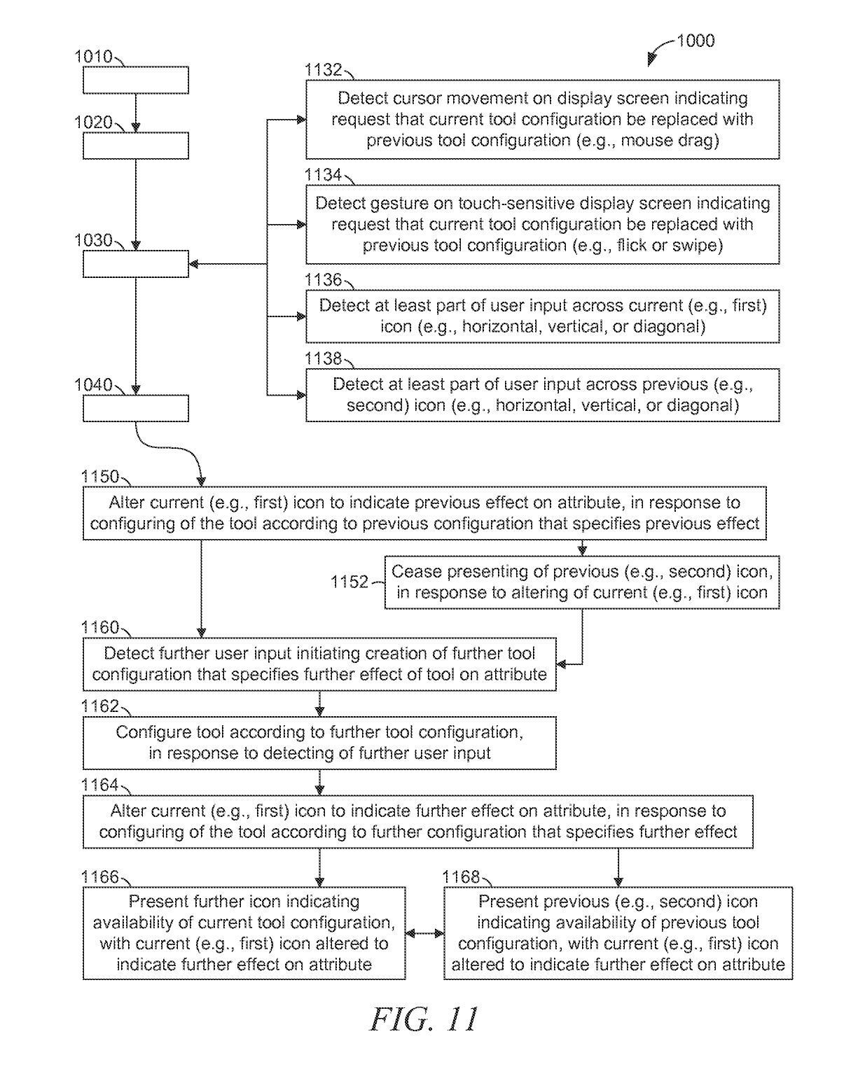

As shown in FIG. 11, the method 1000 may include one or more of operations 1132, 1134, 1136, 1138, 1150, 1152, 1160, 1162, 1164, 1166, and 1168. One or more of operations 1132-1138 may be performed as part (e.g., a precursor task, a subroutine, or a portion) of operation 1030, in which the input module 130 detects the user input indicating the request that the current tool configuration be replaced by the previous tool configuration.

In operation 1132, the input module 130 detects a cursor movement (e.g., mouse over or mouse drag) on the display screen 210. The cursor movement may indicate the request that the current configuration of the tool be replaced with the previous configuration of the tool.

In operation 1134, the input module 130 detects a gesture being performed on the display screen 210 (e.g., a touch-sensitive display screen). The gesture may form all or part of a gesture command and may indicate the request that the current configuration of the tool be replaced with the previous configuration of the tool.

In operation 1136, the input module 130 detects at least part of the user input across the first icon (e.g., icon 230) that indicates the current configuration of the tool (e.g., the icon presented in operation 1010). For example, the input module 130 may detect some or all of the user input as a left-to-right gesture or cursor movement across some or all of the icon 230.

In operation 1138, the input module 130 detects at least part of the user input across the second icon (e.g., icon 430) that indicates the previous configuration of the tool (e.g., the icon presented in operation 1020). For example, the input module 130 may detect some or all of the user input as a left-to-right gesture or cursor movement across some or all of the icon 430.

In operation 1150, the icon module 110 alters the first icon (e.g., icon 230) that indicates a current configuration of the tool (e.g., the icon presented in operation 1010). The icon module 110 may alter the first icon to indicate the previous configuration of the tool. That is, the icon module 110 may alter the first icon to indicate the previous effect of the tool on the attribute. Accordingly, the first icon may be modified, revised, replaced, or refreshed in appearance so as to indicate the previous effect of the tool (e.g., paint with the medium circular brush size). For example, the first icon may take the appearance of the icon 230 as depicted in FIG. 5.

In operation 1152, the history module 120 ceases the presenting of the second icon (e.g., item 430) described above with respect to operation 1020. The history module 120 may cease the presentation of the second icon in response to the altering of the first icon in operation 1150. In some example embodiments, the icon module 110 causes the history module 120 to cease the presenting of the second icon, in response to performance of operation 1150. For example, the second icon may be omitted from the display screen 210 (e.g., as depicted in FIG. 5).

In operation 1160, the input module 130 detects another user input (e.g., a further user input) that initiates (e.g., requests initiation of) creation of a new configuration of the tool (e.g., a further configuration of the tool) within the user interface (e.g., display screen 210). This new configuration may specify a new effect (e.g., a further effect) of the tool on the same attribute (e.g., color) of the content 220 presented in the user interface (e.g., paint with a small circular brush size). For example, the new configuration may be created through use of the configuration interface 330 (e.g., as illustrated in FIG. 7).

In operation 1162, the tool module 140 configures the tool according to the new configuration (e.g., further configuration) of the tool. As noted above, the new configuration of the tool may specify the new effect of the tool on the attribute of the content 220 (e.g., paint with the small circular brush size). The tool module 140 may perform operation 1162 in response to the detecting of the user input in operation 1160.

In operation 1164, the icon module 110 alters the first icon (e.g., icon 230) to indicate the new effect (e.g., the further effect) on the attribute (e.g., paint with the small circular brush size). The icon module 110 may alter the first icon in response to the configuring of the tool in operation 1162. For example, the first icon may take the appearance of the icon 230 as depicted in FIG. 8.

In operation 1166, the history module 120 presents a new icon (e.g., a further icon) that indicates availability of the tool configuration discussed above with respect to operation 1010. In other words, the new icon (e.g., icon 530) may indicate availability of the tool configuration described as “the current configuration” in operation 1010. Accordingly, the new icon may indicate the effect of the tool described as “the current effect” in operation 1010 (e.g., paint with the large circular brush size). For example, the new icon may have the appearance of the icon 530 (e.g., as depicted in FIG. 9). According to various example embodiments, the new icon may be presented contemporaneously with the first icon (e.g., icon 230), as altered in operation 1164.

In operation 1168, the history module 120 presents (e.g., redisplays) the second icon (e.g., icon 430) that indicates availability of the previous tool configuration discussed above with respect to operation 1020. As noted above, the previous configuration may specify a previous effect (e.g., paint with a medium circular brush size) of the same tool on (e.g., applicable to) the same attribute (e.g., color) of the content 220 presented in the user interface, and the second icon (e.g., icon 430) may indicate the previous effect of the tool (e.g., paint with the medium circular brush size) the content 220 presented in the user interface. For example, the second icon may have the appearance of the icon 430 (e.g., as depicted in FIG. 9). According to various example embodiments, the new icon may be presented contemporaneously with the first icon (e.g., icon 230), as altered in operation 1164.

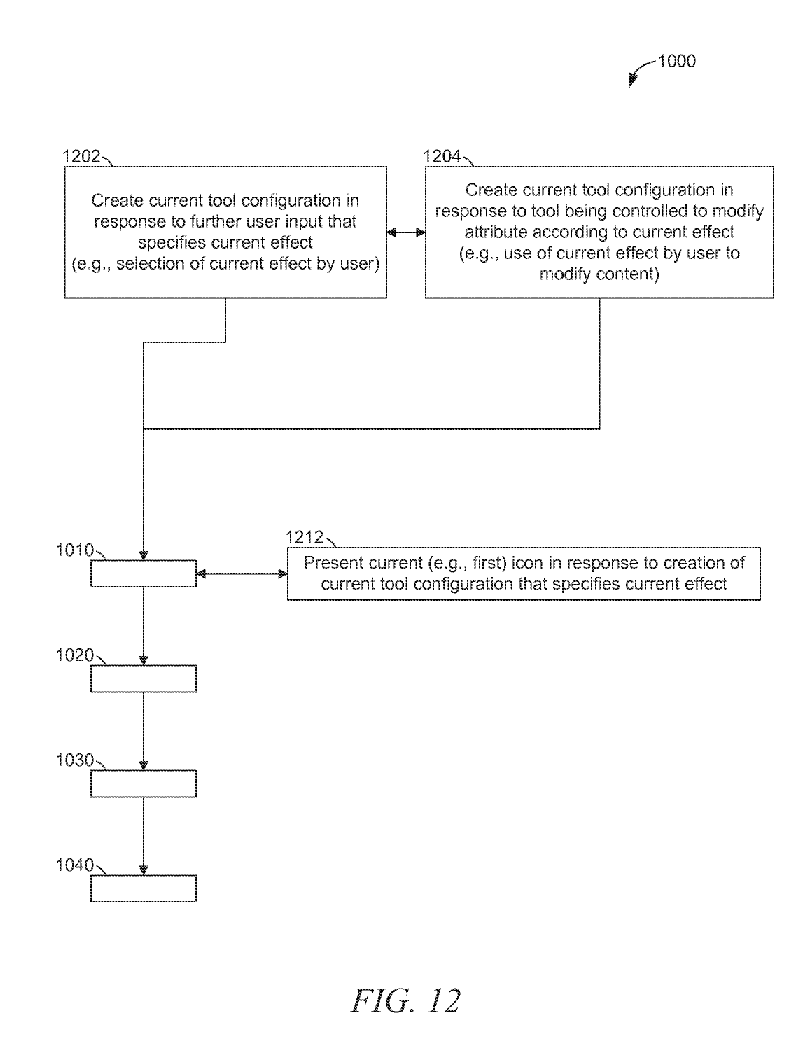

As shown in FIG. 12, the method 1000 may include one or more of operations 1202, 1204, and 1212. One or both of operations 1202 and 1204 may be performed prior to operation 1010, in which the icon module presents the first icon (e.g., icon 230).

In operation 1202, the input module 130 creates the configuration of the tool indicated by the first icon (e.g., icon 230) discussed above with respect to operation 1010. In example embodiments that include operation 1212, the input module 130 may create this tool configuration based on (e.g., in response to) a user input submitted via the configuration interface 330 and detected by the input module 130 (e.g., via the user interface module 190). For example, the input module 130 may create this configuration in response to the user touching or clicking the “OK” button shown in the configuration interface 330 (e.g., as depicted in FIG. 3). According to various example embodiments, this feature may be described as “creating a new tool configuration by user selection.” Such a feature may have the technical benefit of allowing a user to explicitly define new tool configurations by explicitly selecting one or more effects of the tool from a configuration interface (e.g., configuration interface 330).

In operation 1204, the input module 130 creates the configuration of the tool indicated by the first icon (e.g., icon 230) discussed above with respect to operation 1010. In example embodiments that include operation 1204, the input module 130 may create this tool configuration based on (e.g., in response to) the tool actually being used to modify some or all of the content 220. In other words, the input module 130 may create this tool configuration in response to the tool being actually controlled (e.g., by the user) to modify the attribute of the content 220 according to the effect configured for the tool. For example, the input module 130 may create this configuration in response to the user painting at least part of the content 220 with a brush size previously selected by the user (e.g., via the configuration interface 330). According to various example embodiments, this feature may be described as “creating a new tool configuration by usage.” Such a feature may have the technical benefit of creating a new tool configuration only when a user actually uses a set of one or more effects of the tool selected from a configuration interface (e.g., configuration interface 330).

Operation 1212 may be performed as part (e.g., a precursor task, a subroutine, or a portion) of operation 1010, in which the icon module 110 presents the first icon (e.g., icon 230). In operation 1212, the icon module 110 presents the first icon in response to the creation of a new configuration of the tool (e.g., as performed in operation 1202, 1204, or any suitable combination thereof). This may have the effect of indicating to the user that the new configuration has been created and is currently active (e.g., the tool is currently configured with this new configuration).

According to various example embodiments, one or more of the methodologies described herein may facilitate presentation of a timeline or history of tool configurations in a user interface. Moreover, one or more of the methodologies described herein may facilitate convenient comparison of tool configurations with each other. Hence, one or more the methodologies described herein may facilitate retrieval and reuse of tool configurations.

When these effects are considered in aggregate, one or more of the methodologies described herein may obviate a need for certain efforts or resources that otherwise would be involved in storing, retrieving, comparing, using, and reusing tool configurations. Efforts expended by a user in identifying a desired tool configuration may be reduced by one or more of the methodologies described herein. Computing resources used by one or more machines, databases, or devices (e.g., the device 100) may similarly be reduced. Examples of such computing resources include processor cycles, network traffic, memory usage, data storage capacity, power consumption, and cooling capacity.

FIG. 13 is a block diagram illustrating components of a machine 1300, according to some example embodiments, able to read instructions from a machine-readable medium (e.g., a machine-readable storage medium) and perform any one or more of the methodologies discussed herein. Specifically, FIG. 13 shows a diagrammatic representation of the machine 1300 in the example form of a computer system and within which instructions 1324 (e.g., software) for causing the machine 1300 to perform any one or more of the methodologies discussed herein may be executed. In alternative embodiments, the machine 1300 operates as a standalone device or may be connected (e.g., networked) to other machines. In a networked deployment, the machine 1300 may operate in the capacity of a server machine or a client machine in a server-client network environment, or as a peer machine in a peer-to-peer (or distributed) network environment. The machine 1300 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 1324, sequentially or otherwise, that specify actions to be taken by that machine. Further, while only a single machine is illustrated, the term “machine” shall also be taken to include a collection of machines that individually or jointly execute the instructions 1324 to perform any one or more of the methodologies discussed herein.

The machine 1300 includes a processor 1302 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 1304, and a static memory 1306, which are configured to communicate with each other via a bus 1308. The machine 1300 may further include a graphics display 1310 (e.g., a plasma display panel (PDP), a light emitting diode (LED) display, a liquid crystal display (LCD), a projector, or a cathode ray tube (CRT)). The machine 1300 may also include an alphanumeric input device 1312 (e.g., a keyboard), a cursor control device 1314 (e.g., a mouse, a touchpad, a trackball, a joystick, a motion sensor, or other pointing instrument), a storage unit 1316, a signal generation device 1318 (e.g., a speaker), and a network interface device 1320.

The storage unit 1316 includes a machine-readable medium 1322 on which is stored the instructions 1324 (e.g., software) embodying any one or more of the methodologies or functions described herein. The instructions 1324 may also reside, completely or at least partially, within the main memory 1304, within the processor 1302 (e.g., within the processor's cache memory), or both, during execution thereof by the machine 1300. Accordingly, the main memory 1304 and the processor 1302 may be considered as machine-readable media. The instructions 1324 may be transmitted or received over a network 1326 (e.g., a wireless network) via the network interface device 1320.

As used herein, the term “memory” refers to a machine-readable medium able to store data temporarily or permanently and may be taken to include, but not be limited to, random-access memory (RAM), read-only memory (ROM), buffer memory, flash memory, and cache memory. While the machine-readable medium 1322 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., software) for execution by a machine (e.g., machine 1300), such that the instructions, when executed by one or more processors of the machine (e.g., processor 1302), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
presenting a first icon that indicates a current configuration of a tool within a user interface in which content is presented,
the current configuration specifying a current effect of the tool on an attribute of the content presented in the user interface;
presenting a second icon that indicates availability of a previous configuration of the tool within the user interface,
the previous configuration specifying a previous effect of the tool on the attribute of the content presented in the user interface;
detecting a user input indicative of a request that the current configuration of the tool be replaced with the previous configuration of the tool within the user interface; and
configuring the tool according to the previous configuration that specifies the previous effect of the tool on the attribute,
the configuring of the tool being performed by a processor of a machine based on the detecting of the user input indicative of the request that the current configuration of the tool be replaced with the previous configuration of the tool.

2. The method of claim 1, wherein:
the tool is controllable to modify the attribute within at least one of a document, an image, audio data, or video data included in the content presented in the user interface.

3. The method of claim 1, wherein:
the current configuration of the tool specifies the current effect on the attribute as a current color applicable to at least some of the content presented in the user interface; and
the previous configuration of the tool specifies the previous effect on the attribute as a previous color applicable to at least some of the content presented in the user interface.

4. The method of claim 1, wherein:
the current configuration of the tool specifies the current effect on the attribute as a current brush operable to color at least some of the content presented in the user interface; and
the previous configuration of the tool specifies the previous effect on the attribute as a previous brush operable to color at least some of the content presented in the user interface.

5. The method of claim 1, wherein:
the detecting of the user input includes detecting a cursor movement on a display screen that presents the user interface,
the cursor movement indicating the request that the current configuration be replaced with the previous configuration.

6. The method of claim 1, wherein:
the detecting of the user input includes detecting a gesture being performed on a touch-sensitive display screen that presents the user interface,
the gesture indicating the request that the current configuration be replaced with the previous configuration.

7. The method of claim 1, wherein:
the detecting of the user input includes detecting at least part of the user input across the first icon that indicates the current configuration of the tool.

8. The method of claim 1, wherein:
the detecting of the user input includes detecting at least part of the user input across the second icon that indicates availability of the previous configuration of the tool.

9. The method of claim 1, wherein:
the first icon indicates the current effect of the tool on the attribute;
the second icon indicates the previous effect of the tool on the attribute; and the method further comprises
altering the first icon to indicate the previous effect on the attribute in response to the configuring of the tool according to the previous configuration that specifies the previous effect on the attribute.

10. The method of claim 9, wherein:
the presenting of the second icon ceases in response to the altering of the first icon to indicate the previous effect of the tool on the attribute.

11. The method of claim 9 further comprising:
detecting a further user input that initiates creation of a further configuration of the tool within the user interface,
the further configuration specifying a further effect of the tool on the attribute of the content presented in the user interface;
configuring the tool according to the further configuration that specifies the further effect of the tool in response to the detecting of the further user input; and
altering the first icon to indicate the further effect on the attribute in response to the configuring of the tool according to the further configuration that specifies the further effect on the attribute.

12. The method of claim 11 further comprising:
presenting a further icon that indicates availability of the current configuration of the tool within the user interface,
the presenting of the further icon being contemporaneous with the presenting of the first icon altered to indicate the further effect on the attribute.

13. The method of claim 11 further comprising:
presenting the second icon that indicates availability of the previous configuration of the tool within the user interface,
the presenting of the second icon being contemporaneous with the presenting of the first icon altered to indicate the further effect on the attribute.

14. The method of claim 1, wherein
the presenting of the first icon is in response to creation of the current configuration that specifies the current effect on the attribute.

15. The method of claim 14 further comprising:
creating the current configuration that specifies the current effect on the attribute in response to a further user input that specifies the current effect on the attribute.

16. The method of claim 14 further comprising:
creating the current configuration that specifies the current effect on the attribute in response to the tool being controlled to modify the attribute according to the current effect of the tool.

17. A non-transitory machine-readable storage medium comprising instructions that, when executed by one or more processors of a machine, cause the machine to perform operations comprising:
presenting a first icon that indicates a current configuration of a tool within a user interface in which content is presented,
the current configuration specifying a current effect of the tool on an attribute of the content presented in the user interface;
presenting a second icon that indicates availability of a previous configuration of the tool within the user interface,
the previous configuration specifying a previous effect of the tool on the attribute of the content presented in the user interface;
detecting a user input indicative of a request that the current configuration of the tool be replaced with the previous configuration of the tool within the user interface; and
configuring the tool according to the previous configuration that specifies the previous effect of the tool on the attribute,
the configuring of the tool being performed by the one or more processors based on the detecting of the user input indicative of the request that the current configuration of the tool be replaced with the previous configuration of the tool.

18. The non-transitory machine-readable storage medium of claim 17, wherein:
the first icon indicates the current effect of the tool on the attribute;
the second icon indicates the previous effect of the tool on the attribute; and the operations further comprise
altering the first icon to indicate the previous effect on the attribute in response to the configuring of the tool according to the previous configuration that specifies the previous effect on the attribute.

19. A system comprising:
an icon module configured to present a first icon that indicates a current configuration of a tool within a user interface in which content is presented,
the current configuration specifying a current effect of the tool on an attribute of the content presented in the user interface;
a history module configured to present a second icon that indicates availability of a previous configuration of the tool within the user interface,
the previous configuration specifying a previous effect of the tool on the attribute of the content presented in the user interface;
an input module configured to detect a user input indicative of a request that the current configuration of the tool be replaced with the previous configuration of the tool within the user interface; and
a processor configured by a tool module to configure the tool according to the previous configuration that specifies the previous effect of the tool on the attribute,
the configuring of the tool being based on the detecting of the user input indicative of the request that the current configuration of the tool be replaced with the previous configuration of the tool.

20. The system of claim 19, wherein:
the first icon indicates the current effect of the tool on the attribute;
the second icon indicates the previous effect of the tool on the attribute; and
the icon module is configured to alter the first icon to indicate the previous effect on the attribute in response to the configuring of the tool according to the previous configuration that specifies the previous effect on the attribute.
